(19) United States
(12) Patent Application Publication
(10) Pub. No.: US 2026/0342722 A1
(43) Pub. Date: Oct. 29, 2026

(54) METHODS AND SYSTEMS FOR STATELESS POLICY-BASED HANDLING OF PACKETS IN A COMMUNICATION NETWORK

(71) Applicant: FASTLY, INC., San Francisco, CA (US)

(72) Inventors: Suresh Bhogavilli, Potomac, MD (US); Hossein Lotfi, Bellevue, WA (US); Artur Bergman, Denver, CO (US); Jayson Sakata, Henderson, NV (US)

(21) Appl. No.: 19/187,423

(22) Filed: Apr. 23, 2025

(51) Int. Cl. H04L 45/42; H04L 12/46; H04L 45/28; H04L 45/74

(52) U.S. Cl. CPC H04L 45/42; H04L 12/4633; H04L 45/28; H04L 45/742

(57) ABSTRACT

Systems and methods are provided for implementing policy-based routing of flows in a communication network, such as a content delivery network. More specifically, the systems and methods of certain embodiments provide for the teleporting of traffic or flows between servers, which may be cache nodes in a content delivery network, within a single point of presence and site at network layer 2, as well as teleporting between different points of presence and sites at network layer 3. Layer 3 teleporting may be achieved by encapsulating packets. In response to receiving a teleported packet, systems and methods may provide for direct server responses (e.g., content to a requesting device).

### BACKGROUND

### Technical Field

The present invention relates generally to the field of computing and communication networks and, more particularly, to enhanced handling of packets among different points-of presence (POPs) and different sites within a PoP in a network.

### Description of Related Art

In content delivery networks, edge cloud platforms, and other types of computing and communications infrastructure, locality is not always guaranteed. This means that communication between an end user and a specific server or cluster of servers (a “point-of-presence,” or “PoP”) may not occur within the same region. Due to compliance and data privacy regulations, however, some customers of network providers need their services to be delivered from within a particular region (e.g., from within the United States only or within the European Union only), regardless of where the customer's end users are, or at which PoP the end user's requests and connections first land. This need can be complicated by factors such as load balancing and servers being taken out of service for maintenance.

While one potential solution involves the use of IP anycast and the allocation of a dedicated IP address prefix for each compliance region, such an implementation can suffer from drawbacks, such as increased demand on address space, the need to announce such prefixes only from PoPs within the compliance region, and a lack of control and predictability. Compliance region-specific DNS maps also suffer from potential drawbacks. For example, the use of a compliance region-specific DNS map may not be guaranteed when using an out-of-region DNS server or where an Internet service provider (ISP) DNS influences routing. Also, an end user may be able to bypass compliance controls through manipulation of a local DNS.

Thus, a need exists for improved methods and systems for ensuring that end user requests are forwarded to a PoP within a designated compliance region for processing and serving a response thereto.

### SUMMARY

These and other needs are satisfied by the embodiments disclosed herein. In general, embodiments described herein provide methods and systems of operating a network, such as a content delivery network, having one or more points of presence and multiple sites, each site having one or more servers, which may be part of cache nodes. In certain embodiments, the system receives a packet from an end user device at a first server or cache node of a first site, the packet associated with a request for content. The first server or cache node may evaluate the packet against one or more policy rules, each policy rule including one or more conditions and mapping a landing site, such as the first site, to a serving site, such as a second site. The system (e.g., at the first server or cache node) determines whether the packet satisfies a first policy rule mapping the first site to the second site as the serving site, and if the packet satisfies the first policy rule, the system encapsulates the packet with an outer header identifying the second site and tunnels the packet at network layer 3 to the second site. The second site then provides a direct server response with the requested content to the end user device. If the packet does not satisfy any policy rule, then the system permits the first server or cache node to provide the requested content to the end user device in response to the packet. The determination of whether the packet satisfies the first policy rule may be performed at the operating system level.

In certain embodiments, in connection with the encapsulation, the system (e.g., the second server or cache node) sets an indication to limit the maximum size of packets and advertises a limited maximum packet size, thereby avoiding fragmentation of encapsulated packets.

Further, in certain embodiments, the system (e.g., at the first cache node) determines whether the packet satisfies a second policy rule identifying a second cache node as a serving cache node, and if the packet satisfies the second policy rule, updating the packet header to reflect the MAC address of the second cache node and causes the packet to be teleported to the second cache node at network layer 2. The second cache node then provides a direct server response with the requested content to the end user device.

In still further embodiments, in which the first site has multiple cache nodes and a switch, the first site may receive indications that the first cache node is entering a draining state and a second cache node is a failover cache node for the first cache node. The system may receive at the switch a second packet from the end user device (or another end user device), where the second packet identifies the first cache node as a landing cache node, and the switch redirects the second packet to the second cache node. During a draining period following the first cache node entering the draining state, the system causes the second cache node to respond to the second packet via the first cache node, and outside the draining period, the system causes the second cache node to directly respond to the second packet.

Additional features and advantages of embodiments of the present invention are described further herein. This summary section is meant merely to illustrate certain features of embodiments of the invention and is not meant to limit the scope of the invention in any way. The failure to discuss a specific feature or embodiment of the invention, or the inclusion of one or more features in this summary section, should not be construed to limit the scope of the invention as claimed.

### BRIEF DESCRIPTION OF THE DRAWINGS

The foregoing, as well as the following detailed description of embodiments of the application, will be better understood when read in conjunction with the appended drawings wherein like reference numerals refer to like components. For the purposes of illustrating the systems and methods of the present application, there is shown in the drawings certain embodiments. It should be understood, however, that the embodiments within the scope of the invention are not limited to the precise arrangements, components, structures, systems, features, and embodiments shown, and the arrangements, components, structures, systems, features, and embodiments shown may be used singularly or in combination with other arrangements, structures, systems, features, and embodiments, as would be understood by those skilled in the art based on the disclosure herein.

The drawings are not necessarily drawn to scale and are not in any way intended to limit the scope of this invention, but merely to clarify illustrated embodiments of the invention. In the drawings:

FIG. 1 is a schematic of one communication network according to an embodiment of the present invention;

FIG. 2 is a block diagram of a cache node according to an embodiment;

FIG. 3 is a packet flow diagram according to an embodiment;

FIG. 4 is a schematic illustrating the logical flow of packets through eXpress Data Path (XDP) programs according to an embodiment;

FIG. 5 is a flow diagram illustrating the conceptual packet flow of tunneling according to an embodiment;

FIG. 6 is a schematic illustrating GUE encapsulation packet format according to an embodiment; and

FIG. 7 is a flow diagram illustrating packet handling according to an embodiment.

### DETAILED DESCRIPTIONS OF EMBODIMENTS

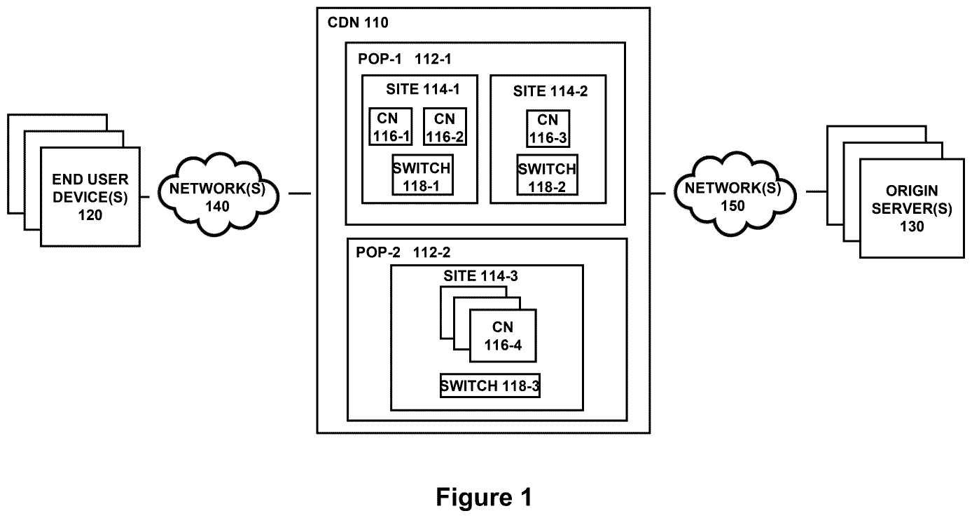

Certain embodiments of the present invention will now be described with reference to the drawings. Turning to FIG. 1, a communication system 100 according to one embodiment is shown. As described in greater detail below, communication system 100 includes an edge network, which includes a content delivery network (CDN) 110, one or more end user devices 120, one or more origin servers 130, and one or more networks 140, 150, such as internet service providers and backhaul networks, via each of which end user devices 120 and origin servers 130 are in communication with CDN 110.

The end user devices 120 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing devices configured to store and access data, and/or to execute software and related applications consistent with the present disclosure.

In various embodiments, the network(s) 140, 150 may represent, for example, an Internet Service Provider (ISP), a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web).

Each network 140, 150 may be any one or more networks that carry data. Non-limiting examples of suitable networks that may be used as network 140, 150 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G), fifth generation (5G), and future generations of cellular-based data communication technologies, Bluetooth radio, Near Field Communication (NFC), the most recently published versions of IEEE 802.11 transmission protocol standards, other networks capable of carrying data, and combinations thereof. In some embodiments, network 140, 150 is chosen from the internet, at least one wireless network, at least one cellular telephone network, and combinations thereof. As such, the network 140, 150 may include any number of additional devices, such as additional computers, routers, and switches, to facilitate communications. In some embodiments, the network 140, 150 may be or include a single network, and in other embodiments the network 140, 150 may be or include a collection of networks. Each network 140, 150 may include multiple points or presence.

CDN 110 includes a plurality of points of presence (“PoPs”) 112, each of which may include one or more sites 114. In general, in the present embodiment, a “site” refers to a co-located set of servers, “cache nodes” and other machines as is known, typically in a single physical facility, attached to the same internet transit, and a PoP refers to multiple servers, “cache nodes,” and other machines as is known that together create a pool of cache storage. Sites may be distributed over a geographic area(s) for lower latency access by end user devices 120 to content normally provided by one or more origin servers 130. By way of example, while the machines that comprise a PoP 112-2 may also comprise a site 114-3, a single PoP 112-1 may comprise multiple sites 114-1, 114-2, as may be the case with so-called metro-PoPs in densely populated areas (for example, a New York City PoP comprising “New York City Site 1” and “New York City Site 2”).

Each site 114 includes one or more cache nodes 116 (also referred to as caches), which cache content from origin servers 130 for delivery to end user devices 120. In general, a cache node 118 in the present embodiment includes a physical server and one or more data storage systems. Each site 114 also includes a switch 118 for directing traffic to the appropriate cache nodes 116.

Cache nodes 116 cache content of one or more origin servers 130; origin servers 130 can include one or more server elements which originate content cached by the cache nodes 116. Such content can include web pages, media content, data, executable code, and/or scripting content, among other types of content. End user devices 120 can request such content from the cache nodes 116 and can responsively receive content transferred by the cache nodes 116 over associated network links and backhaul networks 140. By caching the content of an origin server 130, cache nodes 116 can provide faster access to this content to end user devices 120 and can provide additional capacity to respond to requests for content than that of the origin server 130.

It is to be understood that the number and configuration of PoPs 112, sites 114, and cache nodes (CN) 116 shown are merely meant to be illustrative, as other numbers, arrangements, and configurations are within the scope of the invention.

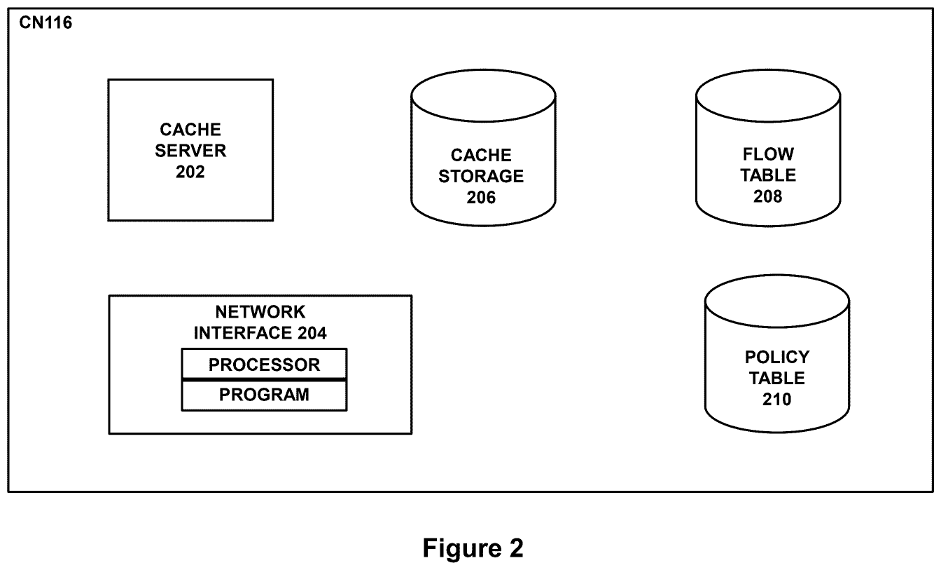

As illustrated in FIG. 2, each cache node 116 may include a physical server 202 having one or more processors operating in accordance with programming on a computer readable medium (e.g., RAM or other memory device) having one or more services listening on one or more TCP and/or UDP ports and a network interface 204 having a network interface card with a device driver. As is known, the network interface card includes a processor operating in accordance with programming residing on a computer readable medium. The server 202 and interface 204 communicate with cache storage 206, which stores content, and flow table 208 and policy table 210, which store teleport rules for directing traffic flow, as described herein. In general, the flow table is a global table that applies to traffic received on all network interfaces, contains flows, and is used to perform packet lookup, modification and forwarding (e.g., based on a 5 tuple key of sourced IP address, source port numbers, destination IP address, destination port number, and the specific protocol in use, for example, TCP UDP). By way of example, data structures storing the policy rules may be BPF maps, which allows for data to be shared between kernel and user space. Cache nodes 106 of the present embodiment also maintain full routing tables for making routing decisions.

As will be appreciated by those of skill based on the present disclosure, embodiments provide for enhanced control over the serving of responses to end user device requests for content. More specifically, certain embodiments provide for functionality to permit the forwarding or “teleporting” of packets not only across different sites 114 within a PoP 112, but also across PoPs 112, as well as provide for teleport functionality for redirecting within a site 114 (and thus PoP 112). As discussed herein, responses to the end user device need not be proxied through the site or cache node from which it is redirected, but rather directly from the site/cache node to which the traffic was redirected. By teleporting packets not only at network layer 3 (L3) between sites 114 and between PoPs 112, but also at network layer 2 (L2) for teleporting within a site 114, traffic is teleported at the lowest layer, which can reduce the resources spent on such traffic. Furthermore, when teleporting between sites 114 or PoPs 112, embodiments are able to enforce teleport rules to determine which PoP 112, site 114, or cache node 116 should receive and respond to an incoming request from an end user device (client) 120. Using such teleport rules, geographic compliance may be ensured. Incoming traffic that satisfies the teleport rules may be tunneled from a “landing” (where the incoming connection or request lands) site 114 or PoP 112 to a “target” or “serving” site or PoP, from which the serving cache responds directly to the end user device 120 or switch—a direct server response to the client. Because the cache node 116 at the serving site 114 or PoP 112 responds directly to the client, the “landing” site 114 or PoP 112 “proxies” only client requests rather than proxying both client requests and server response, as in a traditional proxy server arrangement. The traffic to be teleported may be selectable at individual flow level or in aggregates of various granularities according to the teleport rules. Moreover, it will be appreciated that certain embodiments provide for stateless teleportation, and do not require session state. As such, embodiments provide a tool to assist with selectable traffic engineering.

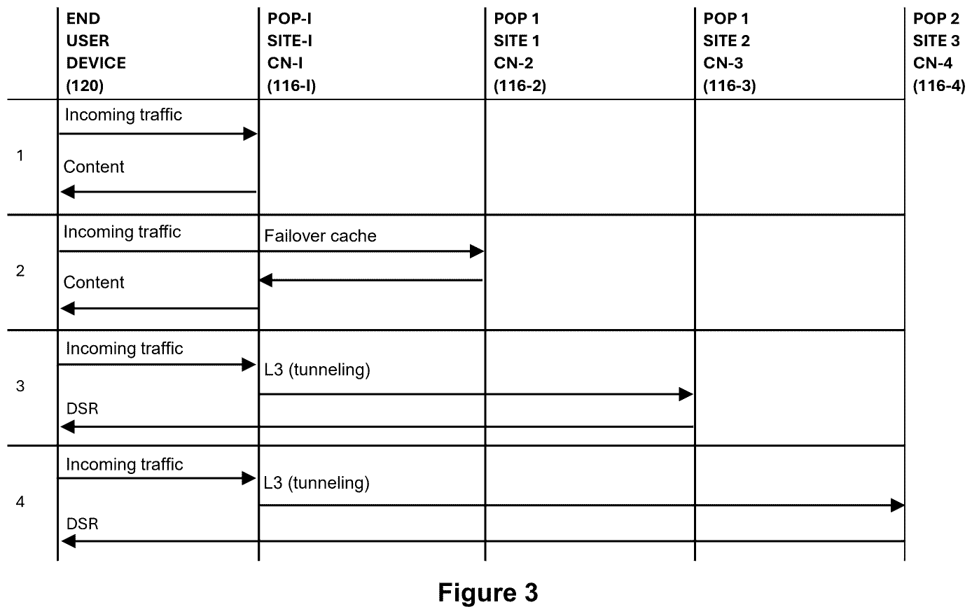

Illustrative packet flows across end user devices 120, PoPs 112, sites 114, and cache nodes 116 will now be described with reference to FIG. 3. In example (1), during normal operation incoming traffic from an end user device 120 received by a PoP 112—here, PoP 112-1—may be directed to site 114-1, cache node 116-1 by switch 118-1. Here, the landing cache node 116-1 is not being drained of traffic (e.g., for being pulled out of service for maintenance), and in the absence of any policy or rule calling for teleporting the received packet, cache node 116-1's network interface delivers the packet to the local Layer 4 (e.g., TCP or UDP) stack and the appropriate listening server application(s) and responds to the request by providing content to the end user device 120.

In certain embodiments, when a cache node 116 enters the draining state (e.g., being removed from service for maintenance and the like), as may be indicated by a configuration setting (e.g., based on the packet's 5-tuple, source address, source port, destination address, destination port, and protocol) that notifies the relevant switch 118 to set the appropriate MAC address to identify the draining cache 116, it may be available for handling traffic for a certain period of time (e.g., a draining period of 120 seconds or some other duration) to allow any existing connections to be closed, without loss of traffic. The draining cache is removed from the list of active cache nodes (nexthops) at the switch 118 and the same flow is mapped to another, failover cache by the switch based on its “5-tuple” (source address, source port, destination address, destination port, and protocol).

In example (2), cache node 116-1 is a draining cache and cache node 116-2 (at the same site 114-1) is the failover cache. As shown, incoming flow from end user device 120 is received at PoP 112-1, and switch 118-1 directs the packets that were previously directed to the draining cache node 116-1 to failover cache node 116-2. This is done at the switch by updating the destination MAC address of downstream packets to reflect that of the failover cache node 116-2, based on the 5-tuple of the packets in the flow from device 120. In the present embodiment, failover cache 116-2 receives the packet and evaluates it to determine whether or not the connection (flow) to which the packet is related is new (i.e., is an initial packet in a flow, as indicated in the tcp header/first packet), or is known to it (i.e., a packet associated with an existing connection/flow, as indicated in its local state table). If the packet is new or known to failover cache 116-2, it processes it, returning content from an origin server 130 stored locally directly to the requesting end user device 120). However, in example (2), failover cache 116-2 determines that it does not have a matching connection for such packets as indicated in its local state table and that the packet is not the first in a new flow connection. As such, during the draining period when draining cache 116-1 is still available, failover cache 116-2 redirects the packet back to the draining cache 116-1, which responds to requesting end user device 120. Note that Layer 2 of draining cache 116-1's response would be sent directly to end user device 120 (via switch 118-1) rather than being proxied back through failover cache 116-2. Should the draining cache 116-1 have been outside the draining period (if any was provided for), then the failover cache node 116-2 would have directly responded to the requesting end user device 120 with a direct server response. Further details and alternate embodiments of draining and failover operations are described in applicant's U.S. Pat. No. 11,245,753, hereby incorporated in its entirety by reference.

Example (3) illustrates other incoming traffic received at the same landing cache node 116-1, but it is not draining. Nevertheless, as indicated in a local flow table 208 the packet is teleported across sites within PoP 112-1, to site 114-2, to serving (or target) cache node 116-3. Cache node 116-3, which contains the request content, provides a direct server response to the requesting end user device 120. As described in greater detail below, in certain embodiments, the packet is identified in the flow table 208 of the landing cache node 116-1 by its 5-tuple and the target cache node 116-3 is identified by its destination IP address and tunneled at L3 across sites based on that IP address. The target cache node 116-3 provides the content via direct server response (rather than being proxied back through landing cache 116-1) to the requesting end user device 120.

Example (4) in FIG. 3 illustrates another example of L3 tunneling according to certain embodiments. End user device 120 provides a request, which for illustrative purposes, is received by the same landing cache node 116-1. After examining its flow table 208 and not finding a match, a packet analysis and/or forwarding rules program associated with network interface 204 of the cache node 116-1 (such as harmonizer_xdp discussed in greater detail below) examines its policy table and identifies a match. Having identified a match in the policy table with the IP address of the serving (target) cache, landing cache node 116-1 teleports the packet by L3 tunneling to the serving cache node 116-4, which is located at another PoP 112-2.

It is to be understood that the Examples (1) through (4) of FIG. 3 are merely illustrative, and the functionality and operations may be combined and occur in different orders. For example, any cache node 116 may be in a draining state. Thus, with reference to Example (3), for example, in the event cache node 116-3 was in a draining state, another cache node at site 114-2 may serve as failover cache. Similarly, for example, traffic received at cache node 116-3 or 116-4 may be tunneled to a cache node (e.g., 116-1) at site 114-1, and such cache node 114-1 may be in a draining state with another cache node (e.g., 116-2) being the failover cache.

As will be understood by those of skill in the art based on the present description, embodiments of the present invention may be built using Extended Berkeley Packet Filter (eBPF), including implementations using traffic control (TC) and eXpress Data Path (XDP), a Linux kernel feature supported for use with the network interfaces 204 (e.g., in the device drivers of a network interface card) used in the cache nodes 116 and in the core network layer of the Linux kernel of the network interface 204. Additionally, Data Plane Development Kit (DPDK), an open source software project managed by the Linux Foundation, may also be utilized to implement the functionality described herein. Further, alternate embodiments may employ so-called smart network interface cards where programming and processing described herein are on the network interface card itself.

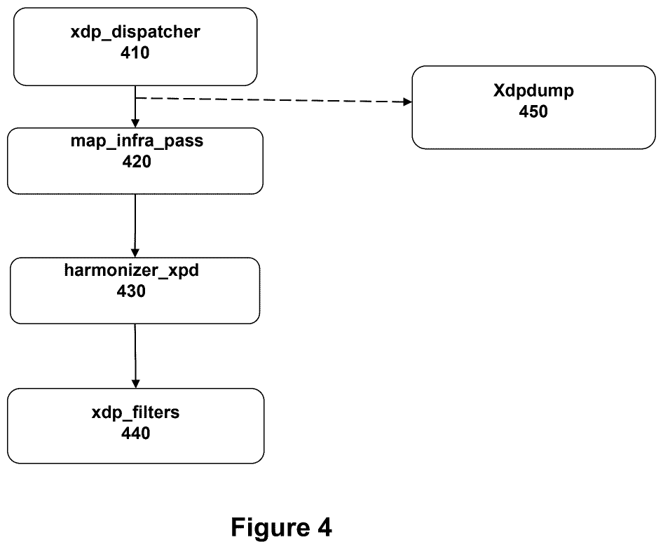

FIG. 4 illustrates various XDP programs handling packets in one such embodiment, in which harmonizer_xdp handles failover and traffic teleporting, and the other programs handle functions like packet capture, as follows.

In general, the XDP programs run within a Berkeley Packet Filter (BPF) or extended Berkeley Packet filter (eBPF) sandbox with access to packet buffers to evaluate and act on packets. Harmonizer_xdp is loaded not only on the network interface, but also in embodiments employing service chaining (e.g., a first service and a second service, which may each be running on the on the same cache node) on the loopback interface for the cache node. To maintain state, XDP programs can use BPF maps of various types (e.g., arrays, hash maps, radix tries). These programs may examine kernel state, such as performing route lookups to determine where to forward packets. A program called xdp-dispatcher progresses a packet through each of the programs. A given XDP program can return one of the following verdicts:
XDP_DROP: Drop the packet. This causes the network interface (e.g., the device driver of a network interface card) to drop the packet and free its memory;
XDP_PASS: Progress the packet to the next XDP program in the flow or to the Linux kernel;
XDP_TX: Send the packet back out the same interface it came in. This is typically used after updating the layer 2 or layer 3 header of the packet so it can be delivered to another cache node, as described herein;
XDP_REDIRECT: Send the packet out of a different interface than it came in. This is typically used when the kernel route table or XDP program configuration dictates that the packet be forwarded using a different egress interface.

Turning to the programs (or modules) depicted in FIG. 4, xdp_dispatcher 410 is an upstream program from the XDP tools project that arbitrates packet handling through the loaded XDP programs in the order of their configured priorities, as shown. map_infra_pass 420 is an XDP_PASS program to keep XDP functionality enabled in the network interface (e.g., device driver). harmonizer_xdp 430 handles the data path drain support (such as shown in example 2 of FIG. 3) based on the destination MAC address at L2. When failover traffic is received by this program at the failover or target cache node 116, it checks to see if there is a matching socket in the kernel. If so, that packet is accepted. Otherwise, it is forwarded to the draining cache. This capability avoids traffic loss during cache maintenance events. Harmonizer_xdp is also the program that provides the functionality described herein for teleporting traffic from a landing cache node (e.g., 116-1 in example 3 of FIG. 3) to a serving cache node (e.g., 116-3 in example 3) where responses are provided by the serving cache node by direct server response to the end user device (or other client). In alternative embodiments, however, the functionality provided by harmonizer_xdp may be provided in multiple programs (e.g., draining/failover functionality in one, and teleporting functionality in another).

Xdp_filters 440 is a program to provide additional packet-level filters (akin to iptables) but implemented at the XDP level and used for security and access control.

Xdpdump 450 is an upstream tool from the xdp-tools project that allows the capture of packets at the ingress or egress point of any XDP program. It does not support selective filtering of packets. So any tcpdump-like filters are applied in user space. By default, xdpdump captures ingress packets to the first XDP program that is loaded. Thus, in the embodiment of FIG. 4, it is the ingress point of the map_infra_pass program 420.

### Harmonizer_xdp 430

According to certain embodiments, harmonizer_xdp 430 supports teleporting traffic at a connection (flow) level and at a packet level driven by policy. As will be appreciated by those skilled in the art, methods and systems according to embodiments of the present invention thus enable teleporting traffic at both L2 and L3, utilizing L2 teleportation when possible to conserve resources (e.g., avoiding tunneling), and provide for selectivity in which packets or flows are teleported.

In general, flow-based teleporting is session stateful at the landing cache. This type may be used when packets are to be teleported to specific target caches selected based on application data, which therefore cannot be teleported statelessly. When an object (e.g., content) requested by an end user device is not cached at the landing cache node, the landing cache node may request another cache having the requested object (e.g., a cluster primary cache) to directly respond to the end user device, as opposed to such other cache providing the requested object back to the landing cache for it to provide to the end user device (i.e., the request is proxied via the landing cache but the response is not, instead it is sent directly from the serving cache to the client). This is referred to as Direct Server Response (DSR). Since the request (end user device) level information is not available in all packets of a given flow, the landing cache maintains the flow state to record the identity of the serving cache and allows application data to access and preserve state information locally on the serving cache.

When a packet arrives at a cache node 116, the cache node 116 first looks for any matching flow table entry based on that packet's 5-tuple. If there is a match, and if the target is identified by the serving cache's MAC address, then the packet is teleported at Layer 2 by overwriting the destination MAC address with the target cache MAC address. If the target cache is identified by a destination IP address, that packet is tunneled using GUE (Generic UDP Encapsulation) to that serving cache, which permits flow-based DSR across multiple sites of a PoP or across PoPs.

Harmonizer_xdp 430 further can support session stateless policy-based teleporting, which, for example, supports compliance routing and traffic engineering (e.g., weighted load distribution across caches).

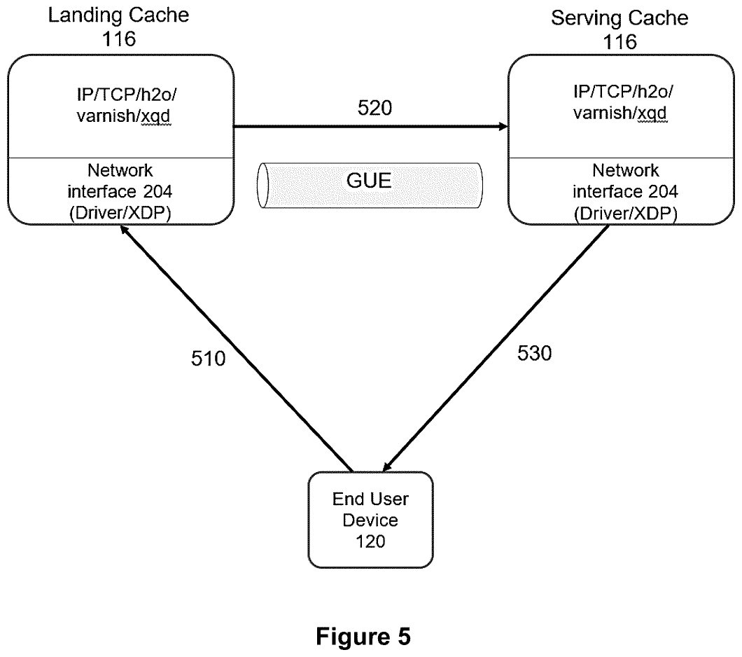

FIG. 5 illustrates the conceptual flow of packets at L3 implemented by harmonizer_xdp according to the present embodiment. In general, the CDN 102 identifies packets to be teleported over network layer 3 (L3) transport to specified target caches between PoPs 112 or between sites 114 within a PoP 112. For example, a packet generated by an end user device 120 arrives at a PoP 112, and switch 118 at that PoP 112 selects a cache node 116 (e.g., according to any of a number of known methods such as Equal Cost Multipath packet forwarding) and forwards the packet to that cache node 116. Such cache node 116 is referred to as the landing cache since that is where the packets of this flow land. The harmonizer_xdp program 430 operating with respect to the network interface of the landing cache examines its flow table and policy table to determine if the packet should be delivered to the local TCP stack and applications, or if it should be teleported to a different, target cache. As noted, such target cache is also referred to as a serving cache since it serves a response to the client directly, using DSR, without proxying it back through the landing cache. When the serving cache is at a different site than the landing cache, that packet may have to be forwarded through one or more provider networks (e.g., the internet) so that the packet is tunneled from the landing cache to the serving cache.

The present embodiment employs Generic UDP encapsulation (GUE) for tunneling, though in alternate embodiments other tunneling protocols, such as Generic Routing Encapsulation (GRE) or Generic Network Virtualization Encapsulation (Geneve), could be used. As GUE encapsulation supports extension headers through flags rather than TLVs (Type-Length-Value encoded data), the cache nodes know (through their software) how to parse a new optional header to accurately parse a packet with that header. In the present embodiment, all of the caches support such header though in alternate embodiments that need not be the case.

To tunnel a packet in the present embodiment, the network interface 204 of the cache node 116 adds a GUE header and encapsulates it over UDP/IP, addressed to the tunnel destination's IP (or VIP) address. The resulting packet is further encapsulated in MPLS and delivered to a local switch 118, where it can be L3 tunneled. Encapsulation may reduce the maximum segment size that can be transported without fragmentation. The maximum segment size for the encapsulated packets may therefore be set low enough (e.g., 1400 bytes) to provide a buffer sufficient to accommodate the encapsulation headers within the packet size of the level 2 MTU (e.g., 1500 bytes for Ethernet) or other maximum packet size limit in order to avoid the need for fragmentation after encapsulation.

In certain embodiments, the serving cache node 116 sets the reduced maximum packet size (e.g., 1400 bytes) via the advertised TCP MSS. When the serving cache node receives a SYN that is teleported to it, it creates a temporary flow table entry to note the need to lower the advertised TCP MSS in corresponding SYN/ACK. The harmonizer_xdp program at the TC CLS stage of packet output examines each outgoing packet to see if it is a TCP SYN/ACK packet and, if so, checks the flow table to see if the TCP MSS has to be adjusted. If, for example, the advertised MSS is over 1400 bytes, then the program lowers it to 1400 and lets the packet go out, thereby ensuring future packets in the flow will be subject to the reduce packet size and thereby avoiding the need for fragmentation.

In contrast to encapsulation for L3 tunneling, if the packets are to be teleported to another cache node 116 at the same site 114, the destination MAC address of the packet is updated and set to the virtual MAC address of the serving cache node 116 and forwarded; no tunneling is used in order to save the processing overhead and bandwidth usage of L3 tunnel headers (described further below).

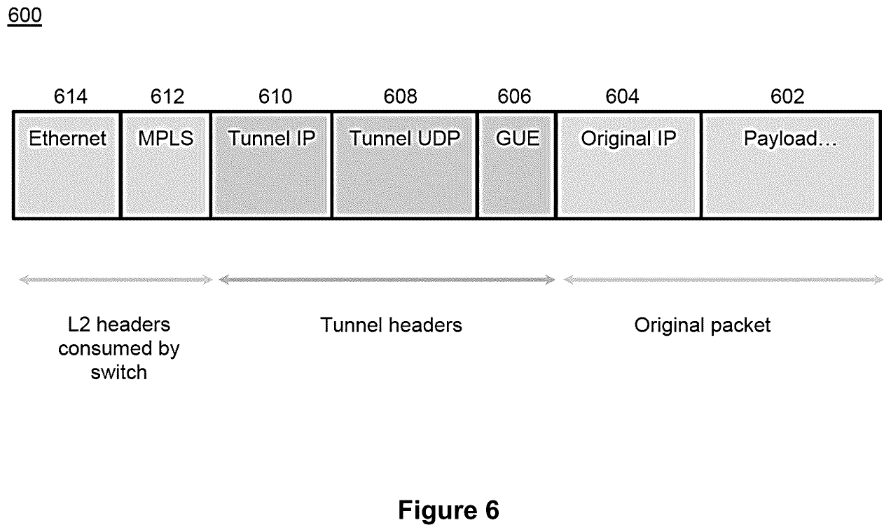

FIG. 6 illustrates the GUE packet format of the present embodiment, including L2 headers that are consumed by the switch 612, 614, tunnel headers 606, 608, 610, and the original packet 604, 602. When tunnelling a packet (600), the source IP address of the outer/tunnel header (610) is set to the inner header's destination IP address (604). In certain embodiments, tunnel destination IP (608) is set to the infrastructure broadcast VIP address of the target (serving) PoP. Using the infrastructure broadcast VIP as the tunnel destination guarantees that the tunneled packet will be handled by the intended target PoP (or if that target PoP withdraws its route announcement, it gets dropped, which is appropriate in a compliance routing scenario).

As such, teleported traffic is not addressed to a specific infrastructure unicast IP address of a cache node at the serving PoP. This frees the landing cache nodes 116 from having to track the state of all remote cache nodes across the CDN 110, which allows the landing caches 116 to be session stateless.

Harmonizer_xdp 430 may perform a lookup in the kernel forwarding information base (i.e., a data structure within the operating system or other database or structure in alternate embodiments) for the tunnel destination IP address, extract the label and preferred nexthop, and MPLS encapsulate the packet before forwarding that packet to a switch 118 associated with the egress interface specified in the route-regardless of the packet's incoming interface. This route lookup also allows harmonizer_xdp 430 to honor any routing policy set by a network operator.

The source port may be computed deterministically, independent of the landing cache 116 that is handling the flow, for example, as a hash of the inner packet's 5-tuple-IP source address, IP destination address, IP source port, IP destination port, and protocol. Since outer source IP, source port, destination IP, and destination port are all algorithmically assigned, a connection that is teleported by the landing PoP 102 is not impacted by the draining of its landing cache. Any cache 116 can step in for the landing cache and the flow would survive landing cache draining events.

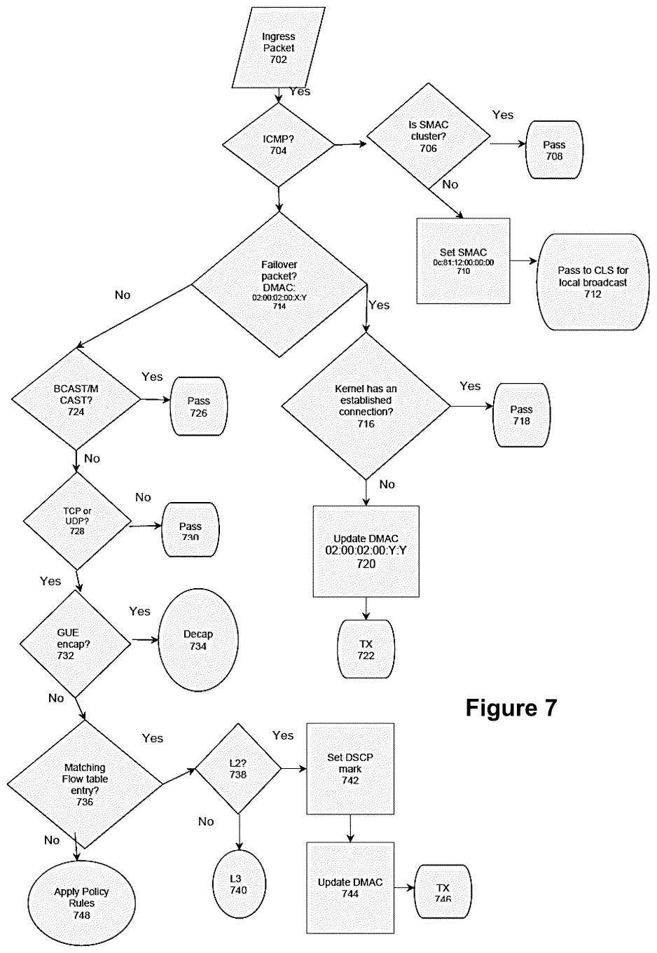

Turning to FIG. 7, packet flow, including as implemented by the harmonizer_xdp program of the present embodiment, will now be described. As shown in FIG. 7, incoming packets are received (702) and processed through harmonizer_xdp program 430.

As will be understood, certain embodiments permit fragmentation of packet flows. In such embodiments, an implementation of harmonizer_xdp may first determine whether the packet is an ICMP (704). More specifically, if the packet is an ICMP type 3 code 4 (Destination Unreachable/Fragmentation needed) message, the program determines whether the packet was already sent by another node (706). If so, the packet is passed and consumed locally (708). If not already sent by another cluster node, the packet is broadcast to all other cache nodes 116 in the cluster (e.g., site 114) by updating the source MAC address (SMAC) to a special address (710), which signals to a companion ebpf module loaded in the kernel traffic control ingress stage for the packet to be rebroadcast (712).

Harmonizer_xdp also checks to see if the packet arrived is for draining traffic (714). If so, the kernel's connection table is checked for a matching established connection or a listening socket (716). When present, the packet is passed and accepted to be consumed locally (718). If not, the packet belongs to a connection on a draining cache, the Destination MAC (DMAC) address is updated (720) and the packet is forwarded to that cache (e.g., via XDP_TX action) for further processing (722).

Harmonizer_xdp also lets the kernel IP stack handle broadcast, multicast, and ICMP traffic. As shown, harmonizer_xdp determines if the packet is an ICMP packet (724) and if so, passes the packet to the kernel without teleporting considerations (726) (though in alternate embodiments, ICMP messages may also be teleported). Harmonizer_xdp then checks to see if the packet is TCP or UDP (728) and, if it is not, passes it to be consumed locally (730).

In the present embodiment, if the packet is TCP or UDP, then the packet is evaluated to determine whether it is GUE encapsulated (732). Because encapsulated packets are those that have already been tunneled, this step is, in essence, a determination of whether the packet has already been tunneled. If so, the tunneled packet has arrived at the desired destination (e.g., serving cache node 116), and harmonizer_xdp decapsulates the packet (734) and passes the inner packet to the kernel IP stack for handling (e.g., responding with requested content). It may also extract metadata for logging and tracing purposes and increment appropriate metrics. Note that no teleport rules are required on the serving cache to decapsulate GUE packets. As will be understood based on the present description, the encapsulated packet may be subject to further policy rules (e.g., requiring further tunnelling from the present site to another site).

For plain TCP and UDP traffic that is received without any GUE tunnel encapsulation, harmonizer_xdp checks to see if the packets need to be teleported (736). Policy governing this action may be in the flow table or the policy table. Harmonizer_xdp first looks for a matching flow table entry. In the present embodiment, the flow table 208 is a global table that applies to traffic received on all network interfaces. It supports teleporting traffic at layer 2 when the target cache is within the same site as the landing cache, and layer 3 teleporting when the target cache is remote (i.e., outside the site of the landing cache). If there is a matching flow table entry, the packet is then either forwarded at L2 (738) or tunneled at L3 over GUE (740) as the matching flow table entry dictates. If it is to be teleported (i.e., forwarded to a target cache for direct server response) at L2 (e.g., forwarded within the same site), the packet is marked (e.g., with DSCP code point 7) so any receiving application can know that this packet has been teleported (742) and the MAC address is updated with the destination MAC (DMAC) address (744) and transported (746). For TCP traffic, in alternate embodiments, the corresponding socket may be marked with a fwmark to access the same information via getsockopt( ).

If (at 736) there is no match in the flow table, harmonizer_xdp examines the teleport policy rules (as stored in the policy table 210) to identify any rule satisfied or matched by the packet and the actions it requires on the packet (748)—namely, whether the packet should be teleported at L3 through tunneling to another PoP 112 and/or site 114 or teleported at L2 through MAC manipulation and forwarding, as described herein. If a packet fails to satisfy any rule, it is not to be tunneled and is allowed to pass up the stack.

One or more policy rules may be applied, and multiple policy rules may be applied in a hierarchical fashion. A rule may have one or more conditions, which, if satisfied, cause the packet to be tunneled to a specified target PoP, target site, or target cache node. Such conditions may, for example, include the packet's source address, destination address, destination port, and/or protocol (either individually or in combination). A rule may provide a mapping of each landing site 114 to its target/serving site 114 such that each cache node 106 looks up its site and finds the mapping to identify its tunnel target site 114. There can be multiple targets for weighted load distribution of teleported traffic.

A rule may enforce geographic compliance by providing that a request for content from a particular origin server 130 or IP address must be served from one or more identified PoPs 112 and/or sites 114 (each PoP 112 may comprise one or more sites 114). If the packet satisfies a rule's condition(s), in one embodiment, harmonizer_xdp causes the packet to be tunneled to a particular site as reflected in the rule. Such tunneling may, for example, be to a specific virtual IP (VIP) address within the CDN 110 (e.g., associated with a particular cache node 116) or the rule may specify multiple target VIP addresses along with weights to be applied in a weighted round robin fashion. For example, in connection with geographic compliance routing requiring content be served from within the European Union, the multiple target VIPs (corresponding to permissible target sites 114 or cache nodes 116) may be those within the EU or a subset thereof.

Additionally or alternatively, the policy rules may be configured to use so-called antipeak sites as targets such that one or more sites are set as a target when such site has relatively low CPU utilization such that it can handle latency insensitive services. The rules may be updated to reflect current antipeak sites or the rules may reflect the times at which each potential site should be available as a target. Additionally or alternatively, policy may also aid in traffic management by teleporting packets to other sites, PoPs, or specific cache nodes using weighted round-robin or other rules.

As will be appreciated by those skilled in the art based on the present disclosure, policy driven teleporting of the present embodiments is session stateless so cache draining does not impact teleported traffic. This also allows for infinite scale in the number of flows that can be teleported.

Although the foregoing embodiments are described with reference to cache nodes in the context of a CDN, the communication network may include an edge computing network having processing nodes other than or in addition to cache nodes. Such processing nodes may be physical servers (e.g., so-called thin servers) or virtual servers (virtual machines (VMs) residing on physical servers). In alternate embodiments, the methods and systems described herein may be applied to routing traffic among such processing nodes. Furthermore, such processing nodes may not be part of an edge network but may, for example, form part of an ISP core network (e.g., network 140 in FIG. 1). Such processing nodes may include associated processor(s) and memory for storing programming instructions, network interface, policy table, and flow table generally as described herein. In such embodiments, L2 and L3 teleportation of user (client) requests may, for example, be dictated at least in part by policies to achieve load balancing within such network. User requests may ultimate be directed to cache nodes for the serving of content to user devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects. Furthermore, aspects of the present invention may take the form of a computer program product embodied in one or more tangible computer readable storage medium(s) having computer readable program code embodied thereon.

The included descriptions and figures depict specific embodiments to teach those skilled in the art. As will be appreciated by those skilled in the art, for the purpose of teaching inventive principles, some conventional aspects have been simplified or omitted. Those skilled in the art will also appreciate variations from these embodiments that fall within the scope of the disclosure and that the features described above may be combined in various ways to form multiple embodiments. As a result, the invention is not limited to the specific embodiments described above, but only by the claims and their equivalents.

What is claimed is:

1. A method of operating a network having one or more points of presence and multiple sites, each site having one or more servers, the method comprising:
receiving a packet from an end user device at a first server of a first site, the packet associated with a request for content and having a header;
at the first server, evaluating the packet against one or more policy rules, each policy rule including one or more conditions and mapping a landing site to a serving site;
at the first server, determining whether the packet satisfies a first policy rule mapping the first site to a second site as a serving site;
if the packet satisfies the first policy rule, encapsulating the packet with an outer header identifying the second site and tunneling the packet at network layer 3 to the second site and causing the second site to provide a direct server response to the end user device; and
if the packet does not satisfy any policy rule, then permitting the first cache node to provide content to the end user device in response to the packet.

2. The method of claim 1 further comprising:
in response to encapsulation, setting an indication to limit the maximum size of packets and advertising a limited maximum packet size, thereby avoiding fragmentation of encapsulated packets.

3. The method of claim 1 wherein the determining whether the packet satisfies the first policy rule is performed at the operating system level.

4. The method of claim 1 wherein the servers include cache nodes and the first server is a first cache node.

5. The method of claim 4 wherein the servers include virtual machines.

6. The method of claim 4 further comprising:
at the first cache node, determining whether the packet satisfies a second policy rule identifying a second cache node as a serving cache node;
if the packet satisfies the second policy rule, updating the packet header to reflect the MAC address of the second cache node and causing the packet to be teleported to the second cache node at network layer 2 and causing the second cache node to provide a direct server response to the end user device.

7. The method of claim 4, wherein the first site has multiple cache nodes and a switch, the method further comprising:
receiving at the first site an indication that the first cache node is entering a draining state and a second cache node is a failover cache node for the first cache node;
receiving at the switch a second packet from the end user device or another end user device, the second packet identifying the first cache node as a landing cache node;
the switch redirecting the second packet to the second cache node; and
during a draining period following the first cache node entering the draining state, causing the second cache node to respond to the second packet via the first cache node and outside the draining period, causing the second cache node to directly respond to the second packet.

8. A network having one or more points of presence (PoP) and multiple sites, each site having one or more servers, the network for receiving requests for content from end user devices and serving content in response to requests from end user devices, the network comprising:
a first server within a first site and a second server within a second site;
the first server operable in accordance with programming instructions in one or more computer readable storage media to:
receive a packet from an end user device, the packet associated with a request for content and having a header;
evaluate the packet against one or more policy rules, each policy rule including one or more conditions and mapping a landing site to a serving site;
determine whether the packet satisfies a first policy rule mapping the first site to a second site as a serving site;
if the packet satisfies the first policy rule, encapsulate the packet with an outer header identifying the second server and cause the packet to tunnel the packet at network layer 3 to the second server; and
if the packet does not satisfy any policy rule, then permit the first server to provide content to the end user device in response to the packet;
the second server operable in accordance with programming instructions in one or more computer readable storage media to:
receive at network layer 3 the tunneled packet; and
provide a direct server response to the end user device in response to the tunneled packet.

9. The network of claim 8, wherein the second server is further operable in accordance with the programming instructions to, in response to encapsulation, setting an indication to limit the maximum size of packets and advertising a limited maximum packet size, thereby avoiding fragmentation of encapsulated packets.

10. The network of claim 8, wherein:
the first server is further operable in accordance with the programming instructions to determine whether the packet satisfies a second policy rule identifying a third server, the third server at the first site;
if the packet satisfies the second policy rule, updating the packet header to reflect the MAC address of the third server and causing the packet to be teleported to the third server at network layer 2; and
the third server is operable in accordance with programming instructions residing on one or more computer readable storage media to provide a direct server response with requested content to the end user device.

11. A server for use in routing packets in a communication network, the server comprising:
one or more processors operative in accordance with programming stored in one or more computer readable media to:
in response to receiving a first packet, evaluate the packet against one or more policy rules, each policy rule including one or more conditions for routing packets between servers;
determine whether the first packet satisfies a first policy rule mapping the server to a second server;
if the first packet satisfies the first policy rule, encapsulate the first packet with an outer header identifying a second server and cause the first packet to be tunneled at network layer 3 to the second server; and
if the first packet does not satisfy any policy rule, then permit the server to respond to the first packet.

12. The server of claim 11, wherein the one or more processors are further operative to:
in response to receiving a second packet, evaluate the second packet and, if the second packet is an encapsulated packet received at network layer 3, provide a direct server response in response to the second packet.

13. The server of claim 12, wherein the one or more processors are further operative to, in response to encapsulation, cause the maximum size of packets to be limited by communicating a limited maximum packet size, thereby avoiding fragmentation of encapsulated packets.

14. The server of claim 11, wherein the server is a physical server.

15. The server of claim 11, wherein the server is a thin server or virtual machine.

16. The server of claim 11, wherein the server is located at a first point of presence and first site in the network and the second server is located at a second site of the first point of presence or a second point of presence.

17. The server of claim 11, wherein the communication network is an edge network including a content delivery network.

18. The server of claim 17, wherein the server comprises thin server or virtual machine and the second server comprises a cache node in the network.

19. The server of claim 12, wherein the server is a first cache node within the network and the one or more processors are further operative to, in response to the first cache node entering a draining state and a second cache node being identified as a failover cache node for the first cache node and receiving a second packet from a client device:
during a draining period following the first cache node entering the draining state, receive content in response to the second packet from the second cache node and cause a response to the second packet including the content to be sent to directly to the client device.
